(19) United States
(12) Patent Application Publication
(10) Pub. No.: US 2017/0093638 A1
(43) Pub. Date: Mar. 30, 2017

(54) METHOD AND NETWORK ELEMENT FOR IMPLEMENTING POLICIES IN A MOBILE NETWORK

(71) Applicant: NOKIA SOLUTIONS AND NETWORKS OY, Espoo (FI)

(72) Inventor: Vilho Ilmari RAISANEN, Helsinki (FI)

(21) Appl. No.: 15/126,678

(22) PCT Filed: Mar. 18, 2014
(86) PCT No.: PCT/EP2014/055397

§ 371 Date: Sep. 16, 2016

(51) Int. Cl. H04L 12/24; H04W 24/02

(52) U.S. Cl. CPC H04L 41/0893; H04L 41/0869; H04L 41/0813; H04L 41/0886; H04W 24/02; H04W 84/18

(57) ABSTRACT

It is described a method for implementing policies in a mobile network (1) with at least one operations and support system (2) and a number of network elements (30 . . . 33) connected thereto. According to said method, a set of policies is validated separately for each network element (30 . . . 33), for which said policy set is relevant. Furthermore, a mobile network (1) and a network element (30 . . . 33) for performing said method are disclosed.

### FIELD OF INVENTION

The present invention relates to a method for implementing policies in a mobile network with at least one operations and support system and a number of network elements. Furthermore, the invention relates to a network element for a mobile network and to a operations and support system for a mobile network. Finally, the invention relates to a mobile network, comprising at least one operations and support system and a number of network elements connected thereto.

### ART BACKGROUND

In self-organizing networks (SON), policies are used for enabling network elements (NE) and the operations and support system (OSS) to autonomously perform pre-defined operations, for example belonging to classes of self-configuration, self-optimization, and self-healing. One aspect of an self-organizing network is to perform configuration loops in network elements themselves so that they observe their own key performance indicators (KPIs) and themselves execute policies to react to predefined situations.

For that reason, distributed policies are created centrally in the operations and support system and deployed to network elements. Policy bases are created by expert personnel, which is costly and makes changing of the policies costly and time-consuming.

This problem is exacerbated by the probable prominent role of machine learning in cognitive networks. Machine learning can identify correlations in data which can be formulated as implications, the latter having the same formal appearance as human-created policies.

There may be a need for an improved method for implementing policies in a mobile network. Particularly, an easier way to create consistent policy bases is desired. In addition the consistency of automatically generated implications with human-created policies shall to be verified.

### SUMMARY OF THE INVENTION

The need to ensure consistency of policies may be met by the subject matter according to the independent claims. Advantageous embodiments of the present invention are described by the dependent claims.

According to a first aspect of the invention there is provided a method as disclosed in the opening paragraph, wherein a set of policies is validated separately for each network element, for which said policy set is relevant.

According to a further aspect of the invention there is provided a network element for a mobile network, comprising means for validating its policy base.

According to a further aspect of the invention there is provided an operations support system for a mobile network, comprising means for sending a validation code to a network element connected to the operations and support system and/or receiving a policy base and the system state from said network element.

According to yet another aspect of the invention there is provided a mobile network as disclosed in the opening paragraph, additionally comprising means for receiving a policy set and means for validating a policy set separately for each network element, for which said policy set is relevant.

These aspects of the invention are based on the idea that validation of a policy base is performed network element by network element, considering the policy set for a network element as one logical domain. Accordingly, policy bases need not to be entirely created by expert personnel necessarily. Thus a mobile network may be operated with less effort. Generally, validation may be performed for example, upon addition of a policy or correlation, a significant change in system status, or in the course of periodical verification of policies relevant to a network element.

According to a further embodiment of the invention the validation is done based on a policy base of said network element and a system state said network element. Accordingly, a mobile network may comprise means for validation based on a policy base of said network element and a system state of said network element. In this way, a comprehensive validation of a policy set respective a policy base may be performed. An example for the system state (variable) is the system time, which may impact the triggering of policies in the network element (e.g. energy saving). Generally, the quality of the validation is improved the more system variables are used in validation. The invention is not limited to the system state (variables) of the network element, but further system variables of the operations and support system can be employed in the validation.

According to a further aspect of the invention there is provided a method, wherein in a first step the consistency of the policies of said policy base is checked without system variables and in a second step the consistency of said policies is checked with respect to current system state. In this way, validation is done hierarchically. Thus, errors in the policies to be validated may be found easier.

According to another aspect in the context above, in a third step the consistency of said policies is checked with respect to potential system states. In this way, future implications of the policies in the policy base on the network can be assessed respectively estimated.

Furthermore, the policies may be interpreted as Horn clauses. A Horn clause is a logical formula in mathematical logic and logic programming. Advantageously, Horn clauses can lead to greater efficiency in proving a policy set.

According to a further aspect of the invention, the network element validates said policy set without data exchange with the operations and support system. Advantageously, no data traffic is caused in the mobile network by the validation of a policy base.

According to a another aspect of the invention the operations and support system sends a validation code to said network element, and said network element validates said policy set by means of the received validation code on request of the operations and support system. Alternatively, said network element requests a validation code from the operations and support system and validates said policy set by means of the received validation code. In both cases, a network element comprises means for receiving a validation code from an operations and support system of said mobile network. Accordingly, a mobile network may comprise means for exchanging validation code between the operations and support system and a network element. Advantageously, the network element needs not to store the validation code but can download it from the operations and support system instead. However, validation as such takes place in the network element, either on request of the operations and support system or on request of the network element.

It should be noted at this point, that “validation code” in the context of the invention generally is used in the meaning of “validation algorithm”. In other words, the validation code is a program or function performing validation. The validation code may be an executable program or code to be interpreted for example.

According to a another aspect of the invention the operations and support system requests the policy base and the system state from said network element and validates said policy set by means of the received policy base and the received system state. Alternatively, said network element uploads its policy base and system state to the operations and support system and the operations and support system validates said policy set on request of said network element. According to these aspects, a mobile network may comprise means for exchanging a policy base of said network element and a system state of said network element between the operations and support system and the network element. Advantageously, the network element again needs not to store or execute the validation code but can upload its policy base and system state to the operations and support system instead. In this case, validation takes place in the operations and support system, either on request of the network element or on request of the operations and support system.

Furthermore, a policy set may automatically be augmented by means of machine learning. In this way, just comparably simple policies have to be entered by humans. Generally, a set of policies may comprise both human-created and automatically generated policies.

According to a further aspect of the invention there is provided a method, wherein on identifying an inconsistent policy set the last addition to the policy base is removed and in a further step the policy base is revalidated. In this way, stability of the processes running in the mobile network is not put at risk. If the policy base is found to be inconsistent, most recently added entries are removed one by one until policy base is consistent. Removals can be performed either in strict temporal order, or by removing automatically created correlations before removing human-created policies. A time stamp indicating last successful validation may be used for switching from correlation removal to deleting human-created policies.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWING

FIG. 1 shows a simplified mobile network with a operations and support system and a number of network elements;

FIG. 2 shows a network element of FIG. 1 in detail;

FIG. 3 shows the interaction between the operations and support system and network elements; and

FIG. 4 shows possible control loops running in the mobile network.

### DETAILED DESCRIPTION

The illustration in the drawing is schematically. It is noted that in different figures, similar or identical elements or features are provided with the same reference signs or with reference signs, which are different from the corresponding reference signs only within the first digit. In order to avoid unnecessary repetitions elements or features which have already been elucidated with respect to a previously described embodiment are not elucidated again at a later position of the description.

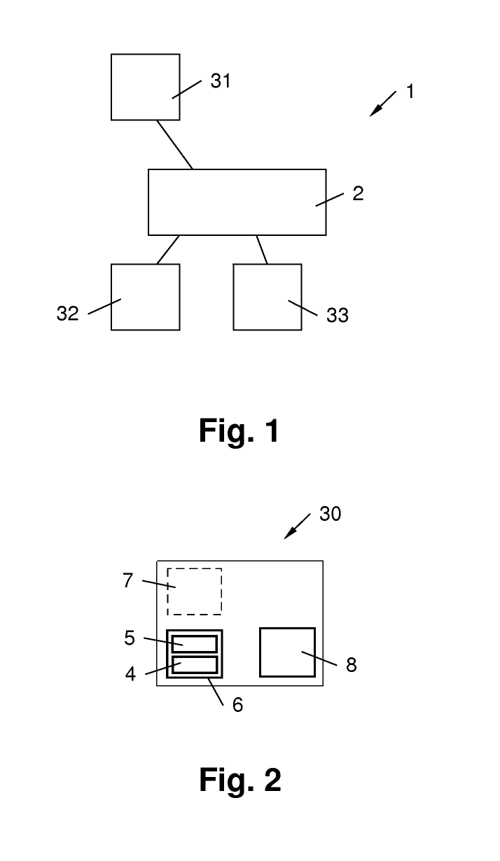

FIG. 1 shows an exemplary mobile network 1, comprising at least one operations and support system 2 and a number of network elements 31 . . . 33 connected thereto. Generally, the operations and support system 2 and the network elements 31 . . . 33 comprise means for exchange data. The mobile network 1 also comprises means for receiving a policy set and means 7 for validating a policy set separately for each network element 31 . . . 33, for which said policy set is relevant. It should be noted, that a mobile network 1 may of course comprise more operations and support systems 2 and network elements 31 . . . 33 than shown in FIG. 1.

FIG. 2 shows an exemplary network element 30 in more detail. The network element 30 comprises a policy base 4 with a number of policies and a system state 5, which usually is defined by a number of system variables. The policy base 5 and the system state (variables) 5 form a knowledge model 6.

Furthermore the network element 30 comprises an optional validation code/validation module 7 and an optional machine learning module 8. Of course, a real network element 30 comprises more entities than shown, for example sending and receiving means, etc. However, for the sake of brevity just entities relevant for the invention are shown in FIG. 2.

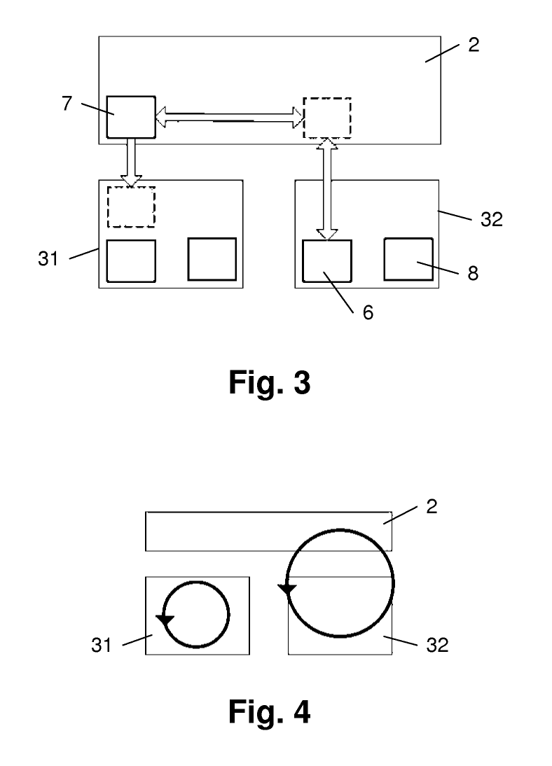

The function of the mobile network 1 is now explained by means of FIG. 3, which shows a operations and support system 2 and two network elements 31 and 32 connected thereto.

Generally, a policy set is validated separately for each network element 30 . . . 33, for which said policy set is relevant, in the disclosed method for implementing policies in a mobile network 1.

Validation advantageously is done based on the policy base 4 of said network element 30 . . . 33 and a system state 5 of said network element 30 . . . 33. Accordingly, the mobile network 1 may comprise means for validation based on a policy base 4 of said network element 30 . . . 33 and a system state 5 of a network element 31, 32.

In a first embodiment, a network element 31, 32 validates a policy set without data exchange with the operations and support system 2. Advantageously, no data traffic is caused in the mobile network 1 by the validation of a policy base 4. Thus, the network element 31, 32 itself comprises means for validating its policy base 4, i.e. the validation code/validation module 7.

In a second embodiment the operations and support system 2 sends the validation code 7 to said network element 31, and said network element 31 validates said policy set by means of the received validation code 7 on request of the operations and support system 2. This case is shown on the left side of FIG. 3.

In a third very familiar embodiment, the network element 31 requests a validation code 6 from the operations and support system 2 and validates said policy set by means of the received validation code 7 (see also left side of FIG. 3).

Hence, in the second and third embodiment the network element 31 comprises means for receiving the validation code 7 from the operations and support system 2 and the operations and support system 2 comprises means for sending the validation code 7 to the network element 31. More generally, the mobile network 1 comprises means for exchanging the validation code 7 between the operations and support system 2 and a network element 31.

Advantageously, the network element 31 needs not to store the validation code 7 but can download it from the operations and support system 2 instead in the second and third embodiment. However, validation as such takes place in the network element 31, either on request of the operations and support system 2 (embodiment 2) or on request of the network element 31 (embodiment 3).

In a fourth embodiment, the operations and support system 2 requests the policy base 4 and the system state 5 from the network element 32 and validates said policy set by means of the received policy base 4 and the received system state 5 (and by means of the validation code 7 stored in the operations and support system 2). This case is shown on the right side of FIG. 3.

In a fifth very familiar embodiment, the network element 32 uploads its policy base 4 and system state 5 to the operations and support system 2, and the operations and support system 2 validates said policy set on request of said network element 32 (see also right side of FIG. 3).

Hence, in the fourth and fifth embodiment the network element 32 comprises means for sending the policy base 4 and system state 5 to the operations and support system 2 and the operations and support system 2 comprises means for receiving the policy base 4 and system state 5 from the network element 32. More generally, the mobile network 1 comprises means for exchanging the policy base 4 and system state 5 between the operations and support system 2 and the network element 32.

Advantageously, the network element 32 again needs not to store the validation code 7 in the fourth and fifth embodiment but can upload its policy base 4 and system state 5 to the operations and support system 2 instead. Validation takes place in the operations and support system 2, either on request of the operations and support system (embodiment 4) or on request of the network element 32 (embodiment 5).

As shown in FIG. 3, the mobile network 1 respectively the operations and support system 2 and the network elements 31, 32 of course may comprise both, means for exchanging a policy base 4 and a system state 5 of said network element 30 . . . 33 between the operations and support system 2 and a network element 30 . . . 33 and/or means for exchanging a validation code 7 between the operations and support system 2 and a network element 30 . . . 33. Accordingly, validation may take place in different ways in one and the same network 1, simultaneously and/or at different places.

Generally, validation may be done in different steps, independent of whether it takes place in the operations and support system 2 or the network elements 30 . . . 33. Advantageously, in a first step the consistency of the policies of said policy base 4 is checked without system variables and in a second step the consistency of said policies is checked with respect to current system state 5.

In this way, validation is done hierarchically. Thus, errors in the policies to be validated may be found easier.

In an optional third step the consistency of said policies is furthermore checked with respect to potential system states.

In this way, future implications of the policies in the policy base on the network 1 can be assessed respectively estimated.

To improve efficiency in proving a policy set, the same may be interpreted as a Horn clause. When validation is performed within the operations and support system 2, furthermore the policy base 4 and the system state 5 can be transformed into other relevant models (e.g. RDF/OWL) for evaluation.

Moreover, a policy set may automatically be augmented by means of the machine learning module 8. In this way, just comparably simple policies have to be entered by humans.

To put the stability of the processes running in the mobile network 1 not at risk, an error handling may be provided. For example, on identifying an inconsistent policy set the last addition to the policy base 4 can be removed and in a further step the policy base 4 can be revalidated.

FIG. 4 finally shows possible control loops running in the mobile network 1. As stated before, validation may take place just in the network element 31 (see left side of FIG. 4) or in cooperation with the operations and support system 2 (see right side of FIG. 4).

In order to recapitulate the above described embodiments of the present invention one can state that validation takes place decentralized network element 30 . . . 33 by network element 30 . . . 33 instead of centrally just in the operations and support system 2.

Finally, it should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

1. mobile network

2 operations and support system

30 . . . 33 network element

4 policy base

5 system state (variables)

6 knowledge model

7 validation code/validation module

8 machine learning module

1. Method for implementing policies in a mobile network with at least one operations and support system and a number of network elements connected thereto, wherein a set of policies is validated separately for each network element, for which said policy set is relevant, the validation is done based on a policy base of said network element and a system state of said network element.

2. (canceled)

3. Method according to claim 1, wherein in a first step the consistency of the policies of said policy base is checked without system variables and in a second step the consistency of said policies is checked with respect to current system state.

4. Method according to claim 1, wherein in a third step the consistency of said policies is checked with respect to potential system states.

5. Method according to claim 1, wherein the policies are interpreted as Horn clauses.

6. Method according to claim 1, wherein said network element validates said policy set without data exchange with the operations and support system.

7. Method claim 1, wherein the operations and support system sends a validation code to said network element, and said network element validates said policy set by means of the received validation code on request of the operations and support system.

8. Method according to claim 1, wherein said network element requests a validation code from the operations and support system and validates said policy set by means of the received validation code.

9. Method according to claim 1, wherein the operations and support system requests the policy base and the system state from said network element and validates said policy set by means of the received policy base and the received system state.

10. Method according to claim 1, wherein said network element uploads its policy base and system state to the operations and support system and wherein the operations and support system validates said policy set on request of said network element.

11. Method according to claim 1, wherein a policy set is automatically augmented by means of machine learning.

12. Method according to claim 1, wherein on identifying an inconsistent policy set the last addition to the policy base is removed and in a further step the policy base is revalidated.

13.-15. (canceled)

16. Mobile network, comprising at least one operations and support system and a number of network elements connected thereto, means for validating the policy set separately for each network element, for which said policy set is relevant, and means for validation based on a policy base of said network element and a system state of said network element.

17. (canceled)

18. Mobile network according to claim 16, comprising means for exchanging
a policy base of said network element and a system state of said network element or
a validation code for validation between the operations and support system and a network element.
